(19) United States
(12) Patent Application Publication
(10) Pub. No.: US 2014/0258057 A1
(43) Pub. Date: Sep. 11, 2014

(54) Method and System to Automatically Track User's Time of Using Mobile Computing Device for Purpose of Billing Clients

(71) Applicants: Alexander Chen, Irvine, CA (US); Michael J. Chen, Tustin, CA (US); Mike Y. Chen, Fremont, CA (US)

(72) Inventors: Alexander Chen, Irvine, CA (US); Michael J. Chen, Tustin, CA (US); Mike Y. Chen, Fremont, CA (US)

(21) Appl. No.: 13/791,854

(22) Filed: Mar. 8, 2013

(51) Int. Cl. G06Q 40/00

(52) U.S. Cl. CPC G06Q 40/105
USPC 705/32

(57) ABSTRACT

A computer-implemented method and system for managing billable hours, the method including the selecting a client from an electronic client directory upon receiving the client's contact for a service; the launching a digital timer for the selected client to record time spent for the requested service; stopping the timer when the service provided for said contact is done; an updating the client's account with the recorded time.

### CROSS-REFERENCE TO RELATED APPLICATION

This application claims the benefit of priority under 35 U.S.C. 119(e) to the filing date of U.S. provisional patent application No. 61608112 “Method and System to Automatically Track User's Time of Using Mobile Computing Device for Purpose of Billing Clients ” which was filed on Mar. 8, 2012, and which is incorporated herein by reference in it entirety.

### FIELD OF THE INVENTION

The disclosed subject matter relates generally to methods and systems for recording time expanded in performing tasks and, more particularly, to methods and systems for automatically recording time and work performed and managing recorded time using a mobile computing platform and a mobile device.

### BACKGROUND

Time is recorded by individuals of an organization to keep track of the time they spend on various tasks relating to the organization. This time data facilitates organizations not only to plan their future strategies, but also to ensure early detection of abnormalities and plan mitigating measures. The effective tracking of time is critical to particular professions when compensations and charges are based upon the amount of time expended to provide a service or complete a project. Examples of professions where time keeping is important include attorneys, doctors and the like. Tracking time is also important for allocating project costs and meeting project completion deadlines. The time information recorded by the individuals of an organization is also useful in budgeting for future projects or services. Hence it is not only essential that individual record time, but also to ensure their accuracy in doing so.

Telecommuting refers to work being done at locations other than a central location. Telecommuters are typically knowledge workers who work primarily on tasks which require mental or intellectual activity, rather than on tasks which require physical or capital intensive work at a central location. Many telecommuters conduct work either at a remote work site or at home. One of the biggest obstacles to implementation of telecommuting is that managers would not be able to tell if their telecommuting employees were actually working. Another obstacle is the problem of how to measure the productivity of telecommuting employees. A manager needs to trust that a telecommuting employee is working and trust is developed through quality communications between the central site and the remotely located telecommuting worker.

Usually, managers are responsible for tracking the amount of time individual team members spend on particular tasks of a project. By accurately tracking time spent on tasks, project managers are able to calculate labor costs associated with implementing the project. Project managers are also able to identify potential inefficiencies in implementing the project by comparing actual time being spent on a task to the time allocated to the task. Project managers are able to utilize the tracked time spent on the project to make adjustments to the project plan as the project is being implemented. Project managers are also able to utilize the information to more accurately plan future projects. Existing time management tools rely on users manually inputting time information. Manually inputting time information can lead to errors and thus inaccurate time information.

Professional knowledge workers, such as psychologists or attorneys, bill their time for work done. The problem of how to monitor their time and activities performed, as well as how to automatically calculate the cost of these activities for accounting purposes, need to be solved. Many invoicing systems rely on the manual inputting of the billable time and a technique is required to determine the accuracy of that billed time. Often, unexpected work is required so that more time is expended than is originally projected and a customer needs to receive accurate documentation for additional time to be billed.

Traditionally, tracking and recording amount of time being spent on each task is done manually using, for example, a timesheet. A timesheet may record the start and end time of tasks, or just the duration. A timesheet may also contain a detailed breakdown of tasks accomplished throughout the project or program. This information may be used for payroll, client billing, and increasingly for project costing, estimation, tracking, and management.

At the end of each day, week, month, or as dictated by policies of the organization, the employee submits the timesheet to an organization's administrator who then manually re-enters the timesheet into the correct systems i.e., payroll, billing, reporting, etc. Both the completion of the timesheet by the worker and the entry of the timesheet into system by the administrator are opportunities for human error.

With the advent of information technology, time recording systems have become more efficient through the use electronic timesheets and recordings. Even so, these time recording systems still requires painful and tedious manual input and processing by individuals. These systems do not allow an individual to record time to a task in real time while performing the task. Thus individuals have to remember their past activities and the time they spent on those tasks in order to record times to those tasks. Thus time data might not be accurate, especially when the data pertains to activities in the not-so-recent past and the granularity or the detail of recorded data might not be enough for a through analysis. Time recording represents an additional overhead for individuals of an organization, since they have to spend time recording time. Increasing the level of detail of recorded time data increases that overhead since individuals end up spending even more time to record their tasks.

The time recording process is an administrative overhead, including sending reminders etc. to individuals to record time spent on an organization's tasks. In addition, the user interfaces of the existing time recording and reporting systems are not very user-friendly.

### OBJECT OF THE INVENTION

It is an object of the invention to provide methods and systems for automatically recording time for work performed using a mobile computing platform and a mobile device.

It is also an object of the invention to eliminate wasteful manual effort in tracking billable hours and producing monthly invoices.

It is also an object of the invention to allow professionals to track their billable hours effortlessly and save their valuable time for more productive work and services.

It is also an object of the invention to provide automated and accurate tracking of work performed.

It is also an object of the invention to provide for a way to track time spent in conversation with clients or other related parties on the telephone.

It is also an object of the invention to provide for a way to track time spent reading, composing, or sending short message service (sms) or texts with clients or other related parties on a mobile device.

It is also an object of the invention to provide for a way to track time spent reading, composing, or sending electronic mails (emails) with clients or other related parties on a mobile device.

It is also an object of the invention to provide for a way to track time spent on work performed by manually triggering the tracking of time.

It is also an object of the invention to provide a way for the user to input the context of the work via typing on the keyboard of the mobile device the nature of the work performed.

It is also an object of the invention to provide a way for the user to input via voice recording through the microphone of the mobile device.

It is also an object of the invention to provide a way for the user to input via photo taken by the camera of the mobile device.

### SUMMARY

In one aspect of the invention, a method to track a user's time in using a mobile computing device for purpose of billing is disclosed comprising embedding an application within a mobile computing device wherein the method comprises: initiating the application by the user; the user initiates a triggering event; the user terminates the triggering event; the application access a registry of the mobile computing device to detect the initiation of the triggering event and the termination of the triggering event; the application records a time of duration of between the initiation of the triggering event and the termination of the triggering event; the application selects a client from a contact registry to associate the time of duration to the client to form a client duration record. In one embodiment, the user further inputs a note wherein the note is associated to the client duration record to form a ready time record. In one embodiment, the triggering event is when the user receives an income phone call. In one embodiment, the triggering event is when the user makes an outgoing phone call. In one embodiment, the triggering event is when the user drafts an email.

In another embodiment, the triggering event is when the user drafts a text. In one embodiment, the note is a voice recording. In one embodiment, identity of the client is entered into the contact registry after the user terminates the triggering event. In one embodiment, the ready time record is uploaded by the application to a database for billing purposes. In one embodiment, the application compiles at least two of the client duration records allowing the user to further input notes at a later time to the client duration records wherein the notes are associated to the client duration records to form ready time records.

In another aspect of the invention, a mobile computer device to track a user's time in using mobile computing device for purpose of billing is disclosed comprising an application embedded within the mobile device, the application comprising: an activation module to initiate the application by the user; an access module to access a registry of the mobile computing device wherein the access module detects a initiation and a termination of a triggering event; a recording module to record the duration of time between the initiation of the triggering event and the termination of the triggering event to form a duration of time record; a contact registry module containing information of at least one client; an association module to associate the duration of time record to the at least one client to form a client duration record. In one embodiment, the application further comprising a note module wherein the note module allows the user to input a note wherein the note module further associate the note to the client duration record to form a ready time record. In one embodiment, the triggering event is when the user receives an income phone call. In one embodiment, the triggering event is when the user makes an outgoing phone call. In one embodiment, the triggering event is when the user drafts an email.

In one embodiment, the triggering event is when the user drafts a text. In one embodiment, the note is a voice recording. In one embodiment, information of the client is entered into the contact registry module after the user terminates the triggering event. In one embodiment, the information of the client is entered into the contact registry module before the user initiates the triggering event. In one embodiment, the note module allows the user to input a note right after the client duration record is formed. In one embodiment, the note module allows the user to input a note some time after the client duration record is formed. In one embodiment, further comprising an uplink module wherein the ready time record is uploaded by the uplink module to a database for billing purposes.

### BRIEF DESCRIPTION OF THE DRAWINGS

The disclosed embodiment may be better understood by referring tot he figures in the attached drawings, as provided below.

FIG. 1 is a schematic flowchart diagram illustrating the flow of events from the triggering of the application to the termination of the application.

FIG. 2 is a schematic illustration of a screenshot of an embodiment of the contact registry or “address book” as available in the mobile device.

FIG. 3 is a schematic illustration of a screenshot of an embodiment of an email composition screen.

FIG. 4 is a schematic illustration of a screenshot of an embodiment of a short message service or text composition screen.

FIG. 5 is a schematic illustration of a screenshot of an embodiment of an ongoing telephone call.

FIG. 6 is a schematic illustration of a screenshot of an embodiment of a menu screen of the application.

FIG. 7 is a schematic illustration of a screenshot of an embodiment of the application for recording notes.

### DETAILED DESCRIPTION OF EXAMPLE EMBODIMENTS

In the following, specific details are set forth to provide a thorough description of various embodiments. Certain embodiments may be implemented without these specific details or with some variations in detail. In some embodiments, certain features are described in less detail so as not to obscure other aspects. The level of detail associated with each of the elements or features should not be construed to qualify the novelty or importance of one feature over the others. Furthermore, the detailed features disclosed below are examples and should not be construed as the extent of the claimed subject matter. Those particular details are provided for a better understanding of the underlying features and elements.

The present invention is a method or a system which allows the use of a mobile computing device to load an application in a smart phone or other mobile device for tracking time for work performed. More specifically, the system and method are implemented through the installation of an application or “app” on a mobile device, such as a smartphone, tablet computer, or other portable device.

The software application can be run on a mobile device via download and installation from sources such as Blackberry App World, Google's Android Google Play Store, Apple's iTune App Store, etc. The software application, once installed and running on the mobile device, allows its user to track and record time on work performed. In particular, the software application has access to the mobile device's contact registry, including contacts emails, phone numbers, and other contact information.

In one embodiment, when the client calls the application is triggered and automatically tracks and records the time. Likewise, when the user calls the clients the application automatically tracks and records the time. The software application accesses the contacts registry or “address book” and records the time spent in conversation with the client corresponding to the contact phone number. In the event the incoming number or out going number is not in the contacts registry, the user has the option of adding the number to the contact registry and record the time to the correct client. Alternatively, if the incoming number is blocked or the unknown, the user may manually assign the number to the corresponding client in order to record the time to that client.

In another embodiment, when the client sends a short message service (sms) or text the application is triggered and automatically tracks the records the time it takes for the user to read the message. Alternatively, when the client sends a sms or text the application is triggered and automatically records a predetermined duration of time. Again, when the user drafts and sends a sms or text the application is triggered and automatically tracks and records the time it takes for the user to draft and send the sms or text. In the event the incoming number or out going number is not in the contacts registry, the user has the option of adding the number to the contact registry and record the time to the correct client.

In yet another embodiment, when a client sends an electronic mail or e-mails the application is triggered and automatically tracks and records the time it takes for the user to read the e-mail. In yet another embodiment, when a client writes an electronic mail or e-mails the application is triggered and automatically tracks and records the time it takes for the user to write the e-mail. Alternatively, when the client sends an email the application is triggered and automatically records a predetermined duration of time, such as, for example, through character or word count. As before, when the user drafts and sends an email the application is triggered and automatically tracks and records the time it takes for the user to draft and send the email to the client. In the event the incoming email or out going email is not in the contacts registry, the user has the option of adding the client's email to the contact registry and record the time to the correct client.

In another embodiment, when the client communicates with the user in other ways the application can be manually triggered to track and record time to the assigned client. Furthermore, when the user performs a task that cannot automatically trigger the application the user can trigger the application and track and record the time to an assigned client.

In another embodiment, when the user tracks and records time for work performed, the user can input the context of the work. The user can input via typing on the keyboard of the mobile device the nature of the work performed. The use can also input via voice recording through the microphone of the mobile device. The user can also input via photo taken by the camera of the mobile device.

Upon tracking and recording the duration of time and inputting the nature of the work performed, the application sends the information to a database in the cloud wherein the user can access the information at a later time. The user may then use the information billing purposes or have the operating system automatically calculates the billing information. This works to save time especially for professionals such as consultant and attorneys who works on hourly basis.

### DETAILED DESCRIPTION OF THE DRAWINGS

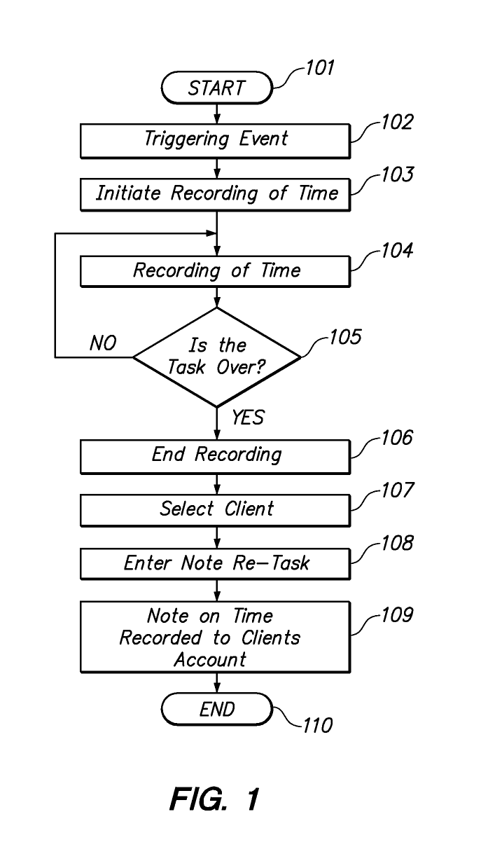

Referring to the drawings that illustrate preferred forms of the present invention, FIG. 1 is a schematic flowchart diagram illustrating the flow of events from the triggering of the application to the termination of the application. Initially the application must be opened and can be run in the background 101 of the mobile device. Then, there must be a triggering event 102 to cause the application to initiate recording of time 103. Upon initiating recording of time 103, the application will continue to record time 104 until the task is over 105. If the task is not yet over, the application will continue to record time 104. If the task is over, the recording will stop 106. The application will then automatically select 107 the client from the contact registry or address book matching the phone numbers, email addresses of the triggering event or the user can manually enter 107 and select the client for associating the recorded time to the client. Next, the use will be prompted to enter a note 108 either through typing or through voice recording regarding the task performed. Finally, the note and the time information will be recorded to the client's account 109, and the process will be terminated 110 to be repeated again. In one embodiment, after the application selects 107 the client from the contact registry and select the client for associating the recorded time to the client, it is store is a table without immediately prompting the user to enter a note 108 to associate the note to the recorded time and the client. After the table compiles more than one recorded time that are associated with the clients, the user can then at a later time input notes to associate the notes to these recorded time. In another embodiment, after the application selects 107 the client from the contact registry and select the client for associating the recorded time to the client, Next, the use will be prompted to enter a note 108 either through typing or through voice recording regarding the task performed. If the user is too busy and decides to hold off entering notes, the time record is store in a table After the table compiles more than one recorded time that are associated with the clients, the user can then at a later time input notes to associate the notes to these recorded time.

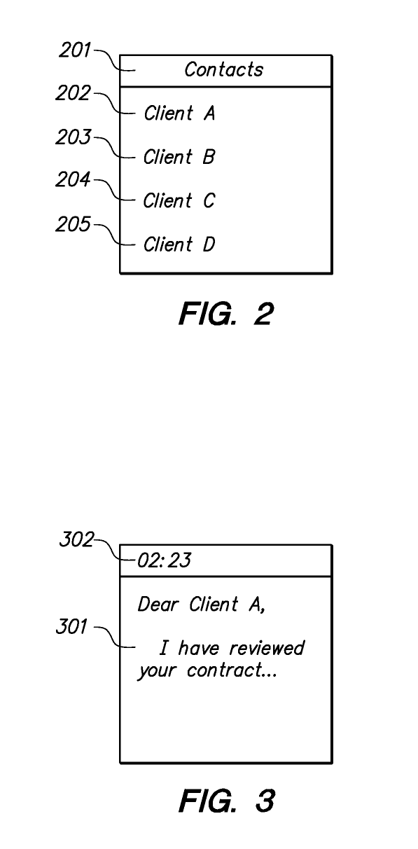

Referring to FIG. 2 is a schematic illustration of a screenshot of an embodiment of the contact registry or “address book” 201 as available in the mobile device. From the contact registry, the user can view a list of clients 202, 203, 204, 205 and choose the corresponding client.

Referring to FIG. 3 is a schematic illustration of a screenshot of an embodiment of an email composition screen. As the user is composing email 301 to a client, the application is triggered to track and record the time 302.

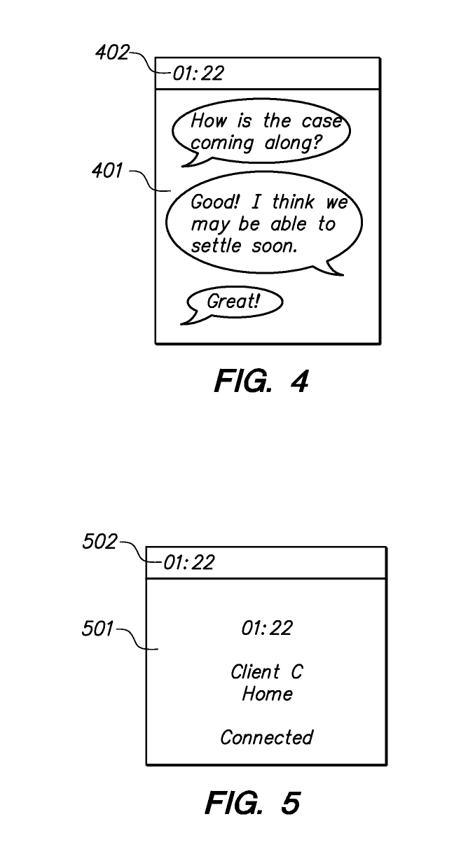

FIG. 4 is a schematic illustration of a screenshot of an embodiment of a short message service or text composition screen. As the user is composing a text 401 to a client, the application is triggered to track and record the time 402.

FIG. 5 is a schematic illustration of a screenshot of an embodiment of an ongoing telephone call. As the user is conversing 502 with a client, the application is triggered to track and record the time 502.

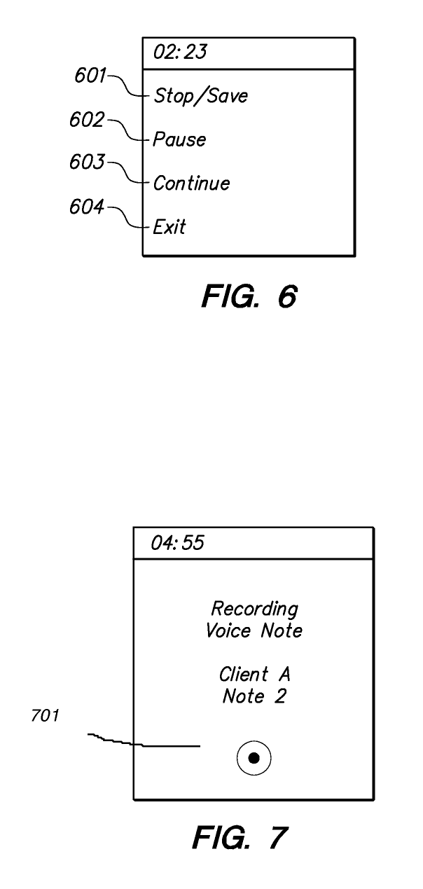

FIG. 6 is a schematic illustration of a screenshot of an embodiment of a menu screen of the application. The user may access the menu to “stop” and “save” 601, “pause” 602, “continue” 603, or “exit” 604 the application.

FIG. 7 is a schematic illustration of a screenshot of an embodiment of the application for recording notes. After tracking and recording the time, the user can input a note or record a note 701 to remind him or herself of the nature of the work performed.

What is claimed is:

1. A method to track a user's time in using a mobile computing device for purpose of billing comprising embedding an application within a mobile computing device wherein said method comprises:
a. initiating said application by said user;
b. said user initiates a triggering event;
c. said user terminates said triggering event;
d. said application access a registry of said mobile computing device to detect said initiation of said triggering event and said termination of said triggering event;
e. said application records a time of duration of between said initiation of said triggering event and said termination of said triggering event;
f. said application selects a client from a contact registry to associate said time of duration to said client to form a client duration record.

2. The method of claim 1 wherein said user further inputs a note wherein said note is associated to said client duration record to form a ready time record.

3. The method of claim 1 wherein said triggering event is when said user receives an income phone call.

4. The method of claim 1 wherein said triggering event is when said user makes an outgoing phone call.

5. The method of claim 1 wherein said triggering event is when said user drafts an email.

6. The method of claim 1 wherein said triggering event is when said user drafts a text.

7. The method of claim 1 wherein said note is a voice recording.

8. The method of claim 1 wherein identity of said client is entered into said contact registry after said user terminates said triggering event.

9. The method of claim 2 wherein said ready time record is uploaded by said application to a database for billing purposes.

10. The method of claim 1 wherein said application compiles at least two of said client duration records allowing said user to further input notes at a later time to said client duration records wherein said notes are associated to said client duration records to form ready time records.

11. A mobile computer device to track a user's time in using mobile computing device for purpose of billing comprising an application embedded within said mobile device, said application comprising:
i. an activation module to initiate said application by said user;
ii. an access module to access a registry of said mobile computing device wherein said access module detects a initiation and a termination of a triggering event;
iii. a recording module to record the duration of time between said initiation of said triggering event and said termination of said triggering event to form a duration of time record;
iv. a contact registry module containing information of at least one client;
v. an association module to associate said duration of time record to said at least one client to form a client duration record.

12. The device of claim 11 wherein said application further comprising a note module wherein said note module allows said user to input a note wherein said note module further associate said note to said client duration record to form a ready time record.

13. The device of claim 11 wherein said triggering event is when said user receives an income phone call.

14. The device of claim 11 wherein said triggering event is when said user makes an outgoing phone call.

15. The device of claim 11 wherein said triggering event is when said user drafts an email.

16. The device of claim 11 wherein said triggering event is when said user drafts a text.

17. The device of claim 11 wherein said note is a voice recording.

18. The device of claim 11 wherein information of said client is entered into said contact registry module after said user terminates said triggering event.

19. The device of claim 11 wherein information of said client is entered into said contact registry module before said user initiates said triggering event.

20. The device of claim 12 wherein said note module allows said user to input a note right after said client duration record is formed.

21. The device of claim 12 wherein said note module allows said user to input a note some time after said client duration record is formed.

22. The device of claim 12 further comprising an uplink module wherein said ready time record is uploaded by said uplink module to a database for billing purposes.
